(19) United States
(12) Patent Application Publication
(10) Pub. No.: US 2014/0232733 A1
(43) Pub. Date: Aug. 21, 2014

(54) Graphics Processing Unit Pre-Caching

(71) Applicant: Jason Caulkins, Issaquah, WA (US)

(72) Inventor: Jason Caulkins, Issaquah, WA (US)

(21) Appl. No.: 13/770,356

(22) Filed: Feb. 19, 2013

(51) Int. Cl. G06T 1/60

(52) U.S. Cl. CPC G06T 1/60
USPC 345/557

(57) ABSTRACT

A method includes searching storage media of a computing appliance for application-specific configuration files by executing a configuration utility from a non-transitory storage medium of the computing appliance, upon finding an application-specific configuration file, directing a graphics processing unit (GPU) driver to partition a portion of GPU random access memory (RAM) as cache, and loading data specified in the configuration file to the cache portion partitioned in the GPU RAM.

### BACKGROUND OF THE INVENTION

1. Field of the Invention

The present invention is in the field of general purpose computers, and pertains particularly to pre-caching data in Graphics Processing Unit Random Access Memory (GPU RAM).

2. Description of Related Art

Computer systems typically have data storage systems from which data is read and to which data is written during program execution. Permanent storage is typically on a disk drive or other persistent media. Computers also typically have Random Access Memory (RAM), which is volatile memory, meaning that the contents are lost when power is switched off. It is well-known that read and write is generally slower with persistent media than with RAM. Because of this, computers in the art often temporarily hold some data in RAM for quicker access by the central processing unit (CPU) or Graphics Processing Unit (GPU). Loading this data prior to the time when it needs to be accessed is called pre-caching.

GPU RAM is connected or dedicated to the graphics processor, and is typically unavailable for use by the CPU, therefore requiring separate techniques for managing its cache.

For optimal performance, computer programs and applications need to access most urgent and frequently used data as quickly as possible. The system will typically ‘learn’ to cache, making that data more readily available. Still, the learning takes time, and does not always produce the optimum performance, especially in the case of GPU RAM, which may need to contain large amounts of infrequently used data. Therefore, what is needed is a method to enable the computer to configure GPU cache data in a manner to optimize performance for graphics-intensive programs.

### BRIEF SUMMARY OF THE INVENTION

In one embodiment of the present invention a method is provided, comprising searching storage media of a computing appliance for application-specific configuration files by executing a configuration utility from a non-transitory storage medium of the computing appliance, upon finding an application-specific configuration file, directing a graphics processing unit (GPU) driver to partition a portion of GPU random access memory (RAM) as cache, and loading data specified in the configuration file to the cache portion partitioned in the GPU RAM.

Also in one embodiment the method includes determining whether the GPU driver is compatible with the configuration utility, and if not, downloading and installing a compatible driver. Also in some embodiments the method includes enabling a user to determine whether or not to download the compatible driver.

In some embodiments the method includes downloading one or more of the configuration utility, GPU driver, and data from an Internet-connected server. Also in some embodiments the method includes executing the configuration utility by executing the GPU driver, the configuration utility being a part of code of the GPU driver.

In some embodiments the method includes determining if there is sufficient GPU RAM available prior to partitioning, and in some others creating an error log when there is insufficient GPU RAM available, or, after initiating the configuration utility, opening an interactive interface enabling a user to select configuration options.

In another aspect of the invention an apparatus is provided, comprising a computing appliance executing instructions by a processor from a non-transitory storage medium, the instructions causing the processor to perform a process comprising searching storage media of the computing appliance for application-specific configuration files by executing a configuration utility from a non-transitory storage medium of the computing appliance, upon finding an application-specific configuration file, directing a graphics processing unit (GPU) driver to partition a portion of GPU random access memory (RAM) as cache, and loading data specified in the configuration file to the cache portion partitioned in the GPU RAM.

In some embodiments the apparatus comprises causing the processor to determine whether the GPU driver is compatible with the configuration utility, and if not, downloading and install a compatible driver. Also in some embodiments the apparatus includes enabling a user to determine whether or not to download the compatible driver. In still other embodiments the apparatus includes downloading one or more of the configuration utility, GPU driver, and data from an Internet-connected server, or executing the configuration utility by executing the GPU driver, the configuration utility being a part of code of the GPU driver.

In some embodiments the apparatus includes determining if there is sufficient GPU RAM available prior to partitioning, and in some embodiments creating an error log when there is insufficient GPU RAM available. In some embodiments, after initiating the configuration utility, the apparatus opens an interactive interface enabling a user to select configuration options.

In some embodiments of both the method and the apparatus the graphics processing unit (GPU) and a central processing unit (CPU) are implemented on a common die, and the processing units share a common random access memory (RAM), a portion of the RAM being dedicated to the GPU, and a portion of the GPU RAM being partitioned as cache.

### BRIEF DESCRIPTION OF THE SEVERAL VIEWS OF THE DRAWINGS

FIG. 1 is an elevation view of a computing appliance that utilizes the invention.

FIG. 2 is an architectural diagram of a network in an embodiment of the present invention.

FIG. 3 is a flow chart illustrating steps in an embodiment of the invention.

FIG. 4 is a flow chart illustrating steps undertaken in another embodiment of the invention.

FIG. 5 is a flow chart illustrating steps undertaken in yet another embodiment of the invention.

FIG. 6 is a block diagram of computing appliance hardware in an embodiment of the present invention.

FIG. 7 is a flow chart illustrating steps undertaken in another embodiment of the invention.

FIG. 8 is an exemplary screen shot of a prompt according to an embodiment of the present invention.

FIG. 9 is an exemplary screen shot according to an embodiment of the present invention.

FIG. 10 is an exemplary screen shot of a prompt in an embodiment of the present invention.

FIG. 11 is an exemplary screen shot according to an embodiment of the present invention.

FIG. 12 is a block diagram of computing appliance hardware in another embodiment of the present invention.

### DETAILED DESCRIPTION OF THE INVENTION

In various embodiments of the present invention a service is provided that configures GPU Random Access Memory (GPU RAM) by using a unique GPU driver to partition a portion of that RAM to be used as cache where data most frequently required by the application may be cached, enabling quick access by the application, thereby optimizing the performance of the application.

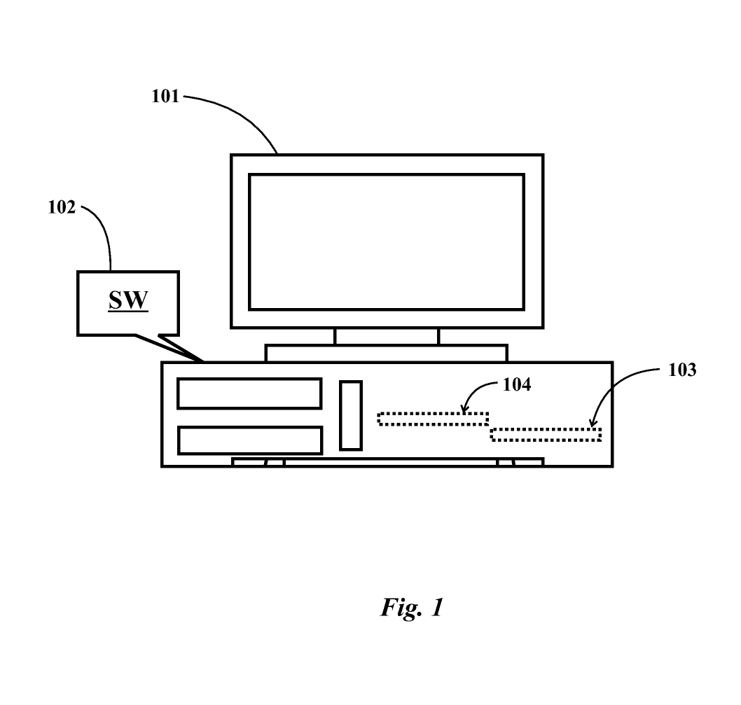

FIG. 1 is an elevation view of a computing appliance 101 that may execute software (SW) 102 from disk drive 103 to execute a graphics-intensive application, such as a 3-D rendering program. Appliance 101 in this example includes a graphics card 104 that has an on-board processor termed herein the graphics processing unit (GPU) as opposed to the CPU of the appliance, and circuitry to more quickly and efficiently manage graphics for SW 102 than could be accomplished with the CPU of the appliance. Graphics card 104 also comprises an onboard Random Access Memory (RAM) that is used for data and code in graphics processing for SW program 102.

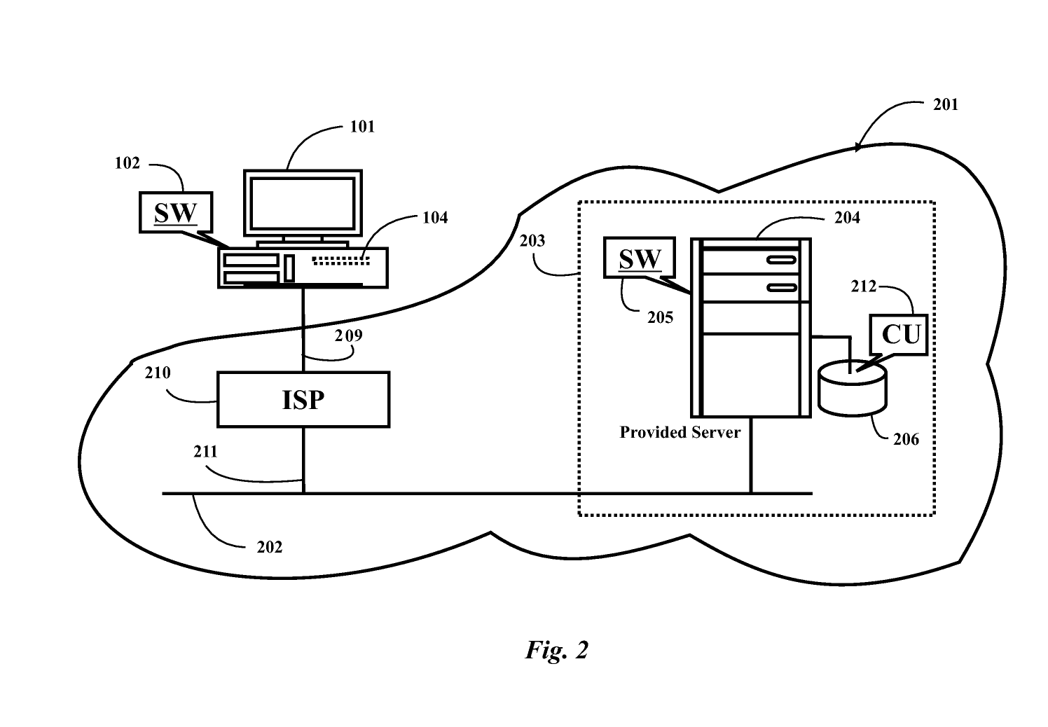

FIG. 2 is an architectural overview of the relationship between computing appliance 101 illustrated in FIG. 1, the well-known Internet network 201 and an inventor-provided service 203 comprising a server (PS) 204 executing software (SW) 205 from a non-transitory medium, and a database (dB) 206 comprising at least a configuration utility (CU) 212 executable by appliance 101. Utility 212 is described in additional detail below.

Internet 201 includes an Internet backbone 202 which represents all of the lines, equipment and access points and sub-networks making up the Internet network as a whole. Therefore there are no geographic limits to the practice of the present invention.

Computer 101 in this example has loaded and is executing software 102. Computer 102 accesses Internet 201 in this example through an Internet Service Provider 210 and a network link 211 via a cable and modem system 209. It should be noted herein that there are other methods available to access the Internet and therefore the example provided should not be construed as a limitation to practicing the present invention. For example access may be achieved via satellite and with wireless technology without departing from the spirit of the invention.

In one embodiment of the invention appliance 101 has downloaded CU 212 from server 204 and installed the CU to execute on appliance 101. An important purpose of CU 212 is to find and utilize configuration files that may be provided by program vendors, such as the vendor for SW 102. In cooperation with service 203 various vendors may provide these configuration files with their SW packages. There will be in this circumstance one configuration file for each graphics application provided by a SW vendor. The configuration file that may be provided by a vendor specifies certain files and data that may be cached in GPU RAM to optimize performance of the specific program associated with the configuration file.

In one embodiment of the invention a CU 212 has been developed to scan a host computer system for configuration files and data that are specific to applications that rely on a GPU to execute. If configuration files are located, the present invention, in one embodiment, may query the driver for the associated program to determine if that driver is supported by the invention, and may be directed to partition a section of GPU RAM to be used as cache and to determine the amount of available GPU RAM for that purpose. If sufficient space is available then files and data specified by the configuration file may be loaded to cache space partitioned in the GPU RAM.

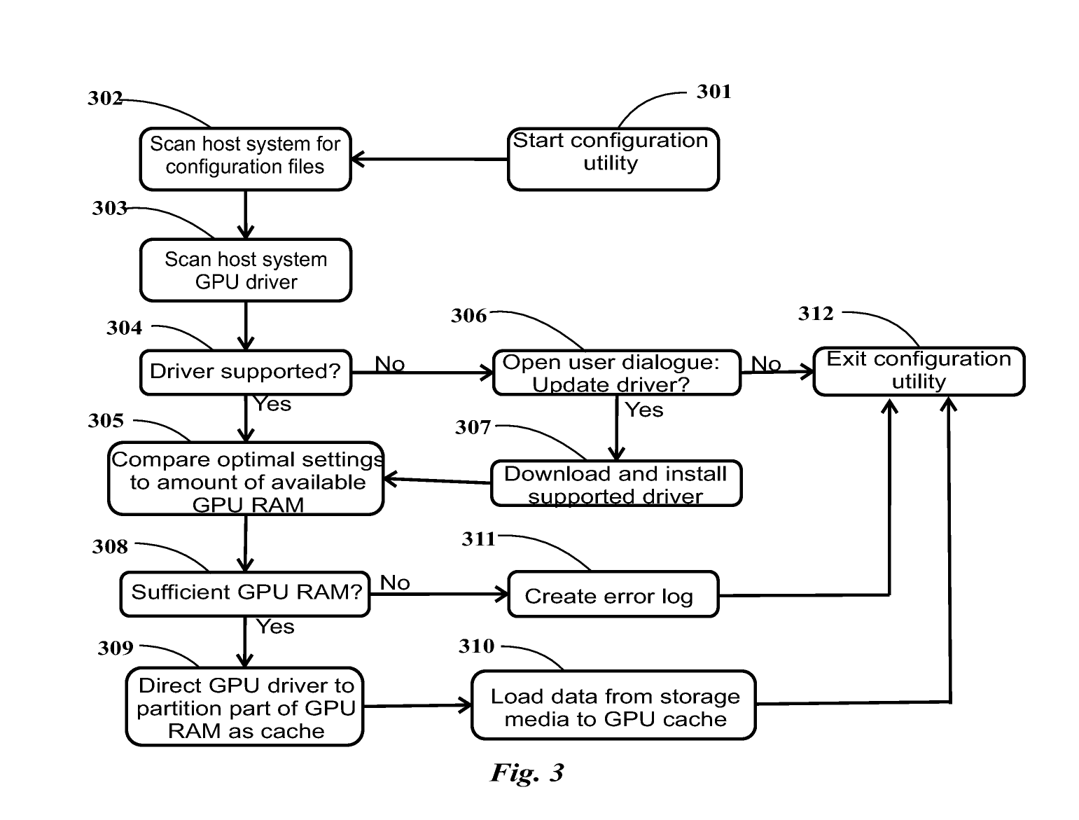

Referring to FIG. 3, in one embodiment of the invention, a configuration utility, previously installed on appliance 101 may start at step 301, when a computer system, such as computer 101, is switched on and its operating system commences operation, without need of personal input. At step 302 the CU scans the host computer system, such as computer 101 in this example, for configuration files and data that were specifically written for particular applications requiring a GPU to execute. It is assumed in this embodiment that at least one configuration file is located in step 302. Once a configuration file is found at step 302, at step 303 the GPU driver of the program associated with the configuration file is queried to determine if that particular GPU driver is supported and therefore capable of partitioning the GPU RAM as cache if instructed.

If the driver is supported (step 304), step 305 compares storage space required for the optimal settings with the amount of GPU RAM available to determine if sufficient space is available. If it is determined that the GPU driver is not supported, an interface 306 may open on screen advising that the driver is not supported and asking the user if an update of the driver is desired. If the response by the user is negative then exiting the configuration utility, step 312, is invoked. Should the user reply positively, then step 307 may cause a GPU driver or update of the GPU driver to be downloaded if the computer system has Internet access. Once step 307 completes, step 305 may commence.

On completion of step 305 either with the GPU driver already supported or now supported after update, a step 308 initiates to consider whether there is sufficient GPU RAM to configure a cache for the associated program. If there is insufficient space an error log is created at step 311. Control then goes to step 312 to exit the configuration utility. If there is sufficient space determined at step 308, at step 309 the driver is directed to partition part of the GPU RAM as cache. If there is sufficient space at step 309, then step 310 commences to load the data specified in the configuration files to partitioned GPU RAM cache. On completion of step 310 the GPU RAM is set up to optimize operation of the associated program for which the configuration file was found at step 302, and step 312 may commence which is to exit the configuration utility.

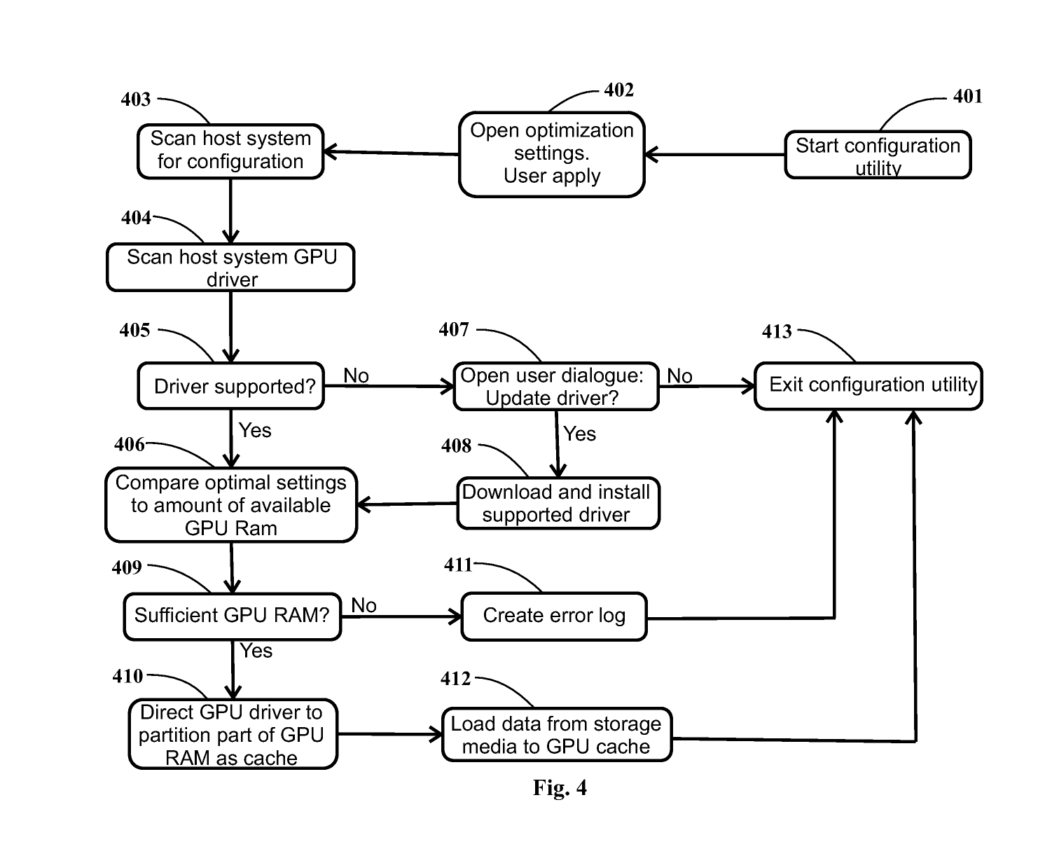

FIG. 4 is a flow chart which illustrates another embodiment of the invention where a configuration utility may start, step 401, when a computer system, such as computer 101, is switched on and its operating system commences operation. The configuration utility starts at step 401 and at step 402 an interactive interface is opened on screen allowing a user to configure the computer for optimization of applications requiring the graphics card. Upon completion of step 402, at step 403 the host computer system is scanned for configuration files and data that are associated with specific programs. Remaining steps 404 through 413 are analogous to steps 303 through 312 of FIG. 3, and operate essentially the same.

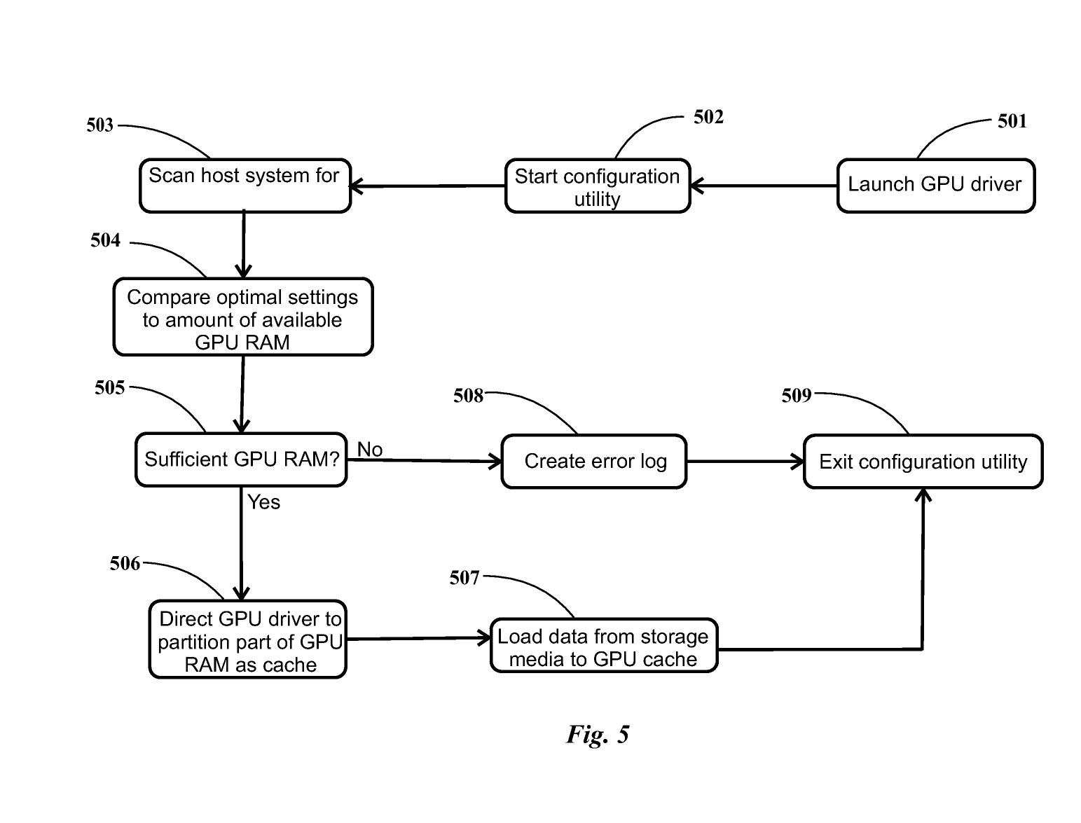

Referring to FIG. 5, in yet another embodiment of the present invention, the configuration utility may be included as part of a GPU driver for a program. The GPU driver will launch in some cases when a program is booted. The launch of the driver in step 501 will start the configuration utility in step 502, which will scan the host system at step 503 for configuration files specifically written for particular applications requiring a GPU to execute. In this embodiment there is no need to query a driver, because the driver was launched at step 501, and if it does not include the configuration utility, the method terminates, and the program will operate without optimization. Step 504 will compare the storage space required for the optimal settings with the amount of GPU RAM available to determine if there is sufficient for the cache. On completion of step 504, step 505 initiates to consider the result of step 504 and control goes to step 508 to create an error log and proceed to step 509 to exit the configuration utility if there is insufficient space, or, to step 506 directing the GPU driver to partition off part of the GPU RAM as cache, if there is sufficient space. If there is sufficient space at step 506, then step 507 commences to load data to that GPU RAM cache. On completion of step 507, step 509 may occur which is to exit the configuration utility.

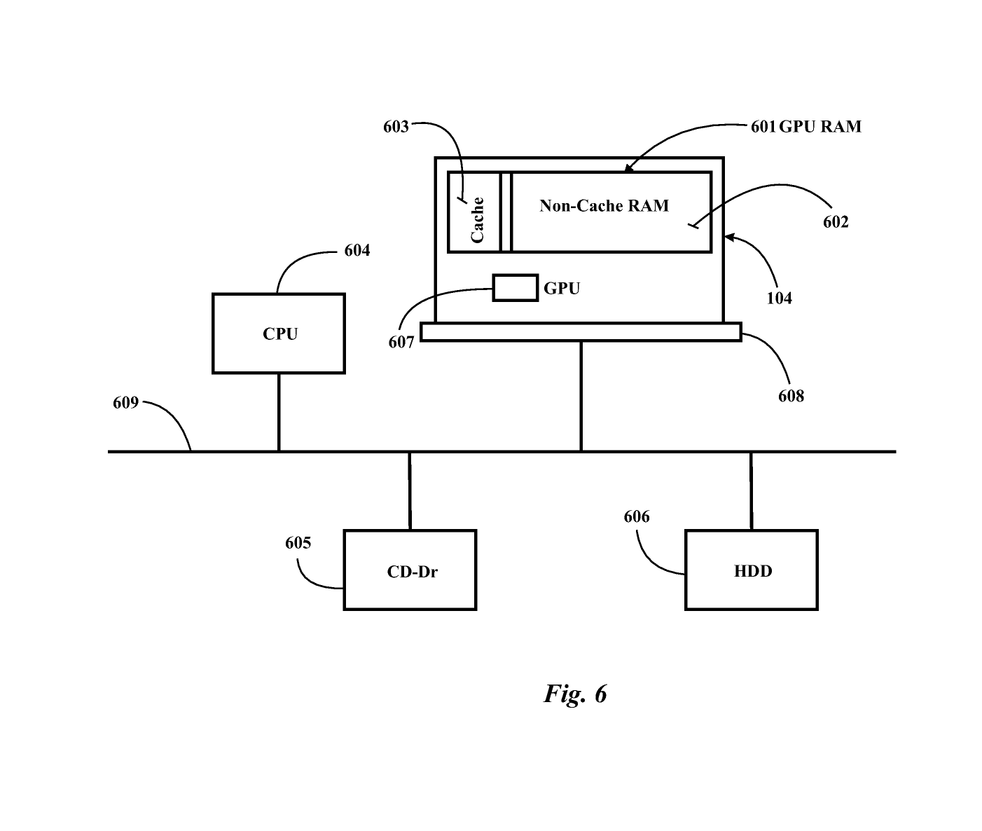

FIG. 6 is a block diagram illustrating elements of general-purpose computer 101, including a CPU 604, hard disk drive (HDD) 606, a CD drive 605, a graphics card 104 and an interconnecting bus 609. Bus 609 is representative of all wires, cables and other hardware and appliances that connect the illustrated elements of the computer system to one another. Graphics card 104 including GPU 607 and GPU RAM 601 is shown connected to bus 609 by an edge connector 608. In some systems the graphics system may be implemented differently, and still comprise a GPU RAM 601. GPU RAM 601 is illustrated as partitioned into a cache portion 603 and a non-cache portion 602, which is accomplished by the driver in various embodiments, directed by the configuration utility for a particular program. In various embodiments of the invention cache 603 is configured to operate selectively with applications that require a graphics card.

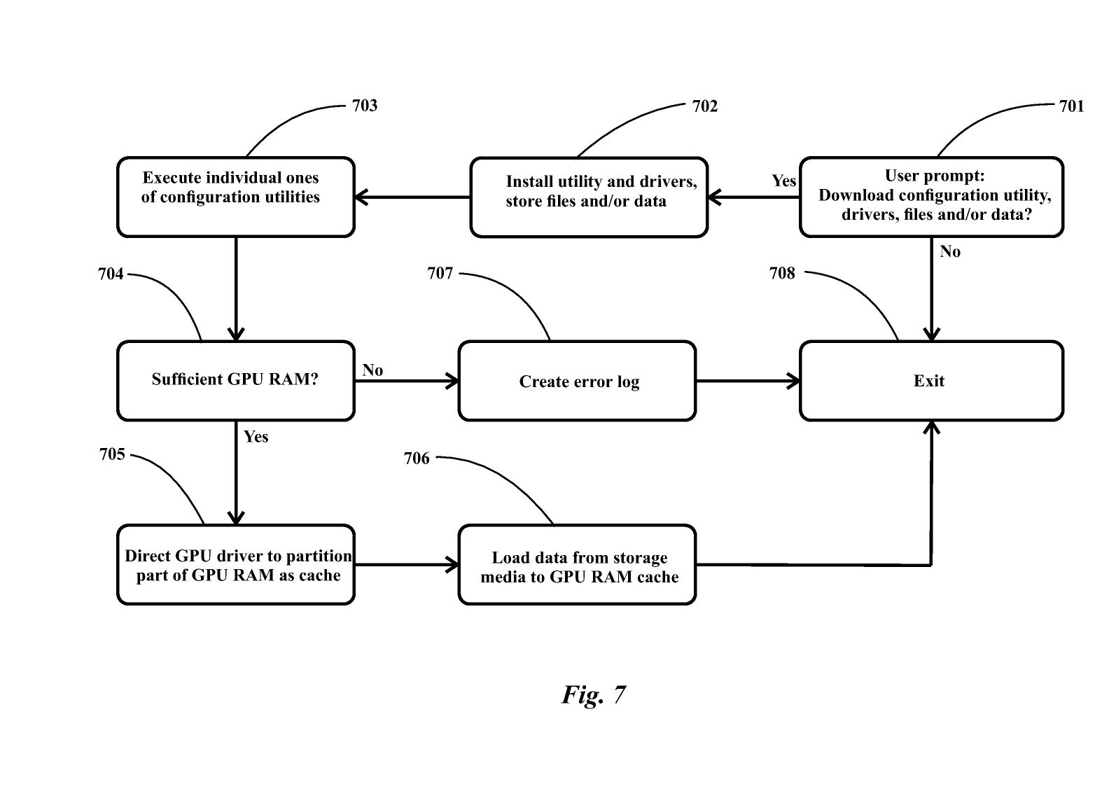

FIG. 7 is a flow chart illustrating yet another embodiment of the present invention. In this embodiment functionality is entirely accessed by a computer through Internet connection to server 204 (FIG. 2). By operation of a browser a user may connect to server 204 and stored dB 206 comprising information and files which have been prepared to optimize programs reliant on a graphics card to execute.

Once connected to PS 204 (See FIG. 2), step 701 provides a user prompt to enable a user to browse, and select to download a configuration utility, drivers, files and/or data, compatible with any one of a plurality of graphics-intensive programs. If the user does not select elements to download at step 701, the process ends at step 708. If the user does select elements at step 701, control goes to step 702 which installs downloaded configuration utility and drivers, and stores files and/or data. Control then goes to step 703 where individual ones of the configuration utilities are executed. Step 704 considers necessary RAM and cache space, and in the event that there is insufficient GPU RAM available, control goes to step 707 which creates an error log transitioning to step 708 which is to exit the configuration utility.

At step 705, if adequate GPU RAM is available to be partitioned as cache then control goes to step 705 which is to direct the GPU driver to perform partitioning of the

GPU RAM into a cache section. On completion of step 705 control goes to step 706 and data are loaded in cache. Once loading is achieved, control goes to step 708 which is to exit the configuration utility. Whatever program was chosen to optimize will now operate in an enhanced manner.

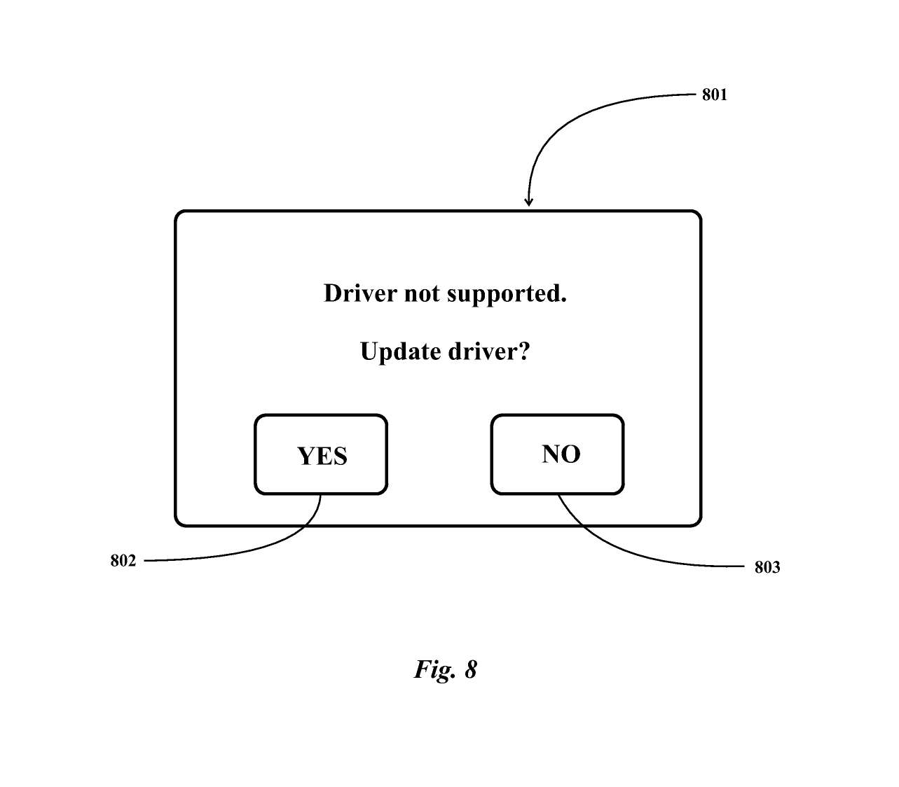

FIG. 8 is an illustration of an exemplary user prompt interface 801 enquiring of a user as to whether an unsupported driver is to be updated in accordance with flow chart illustration FIG. 3, step 306 and/or flow chart illustration FIG. 4, step 407. The user prompt interface 801 provides a button with which to reply in the affirmative marked YES 802 to update the driver and an alternative negative response button marked NO 803 to decline the driver update. In the event that the user selects YES 802 then in the logic flow of FIG. 3, step 306 control will go to step 307 and in the logic flow of FIG. 4, step 407 control will go to step 408 either of which will cause the driver to be updated. If the user selects NO, there will be no update.

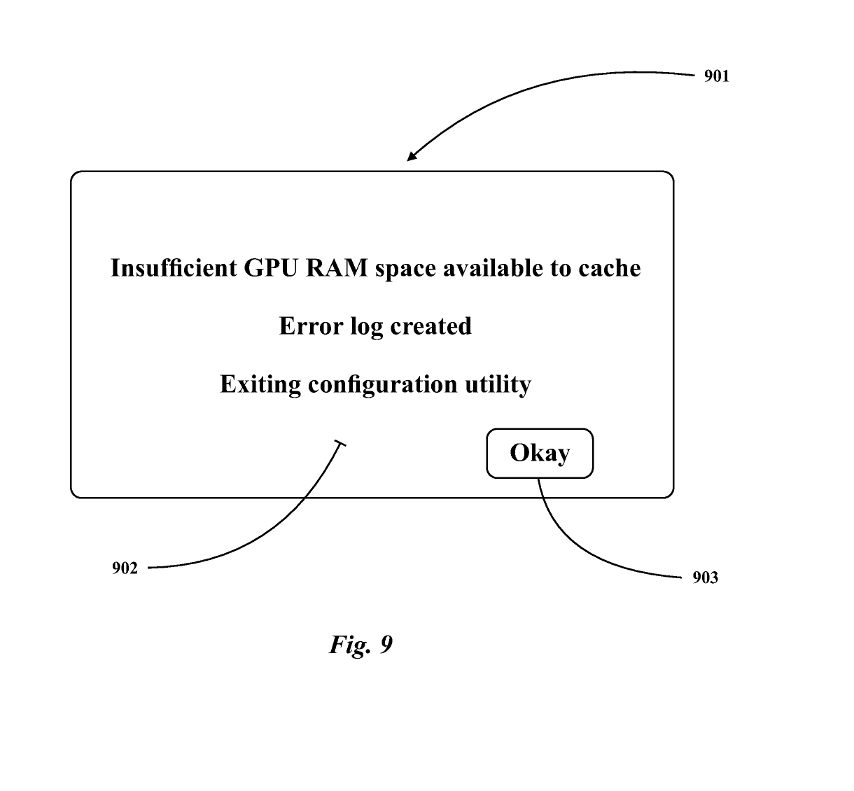

FIG. 9 is an illustration of an exemplary user notification 902 that there was insufficient GPU RAM available to accommodate the caching of optimization data in accordance with FIG. 3, step 311 giving control to step 312 to exit the configuration utility, or in accordance with FIG. 4, step 411, giving control to step 413 to exit the configuration utility, or in accordance with FIG. 5, step 508 giving control to step 509 to exit the configuration utility and in accordance with FIG. 7, step 707 giving control to step 708 to exit the configuration utility and that an error log was created. An illustration of an exemplary button requesting acknowledgment by the user marked OKAY 903 is shown.

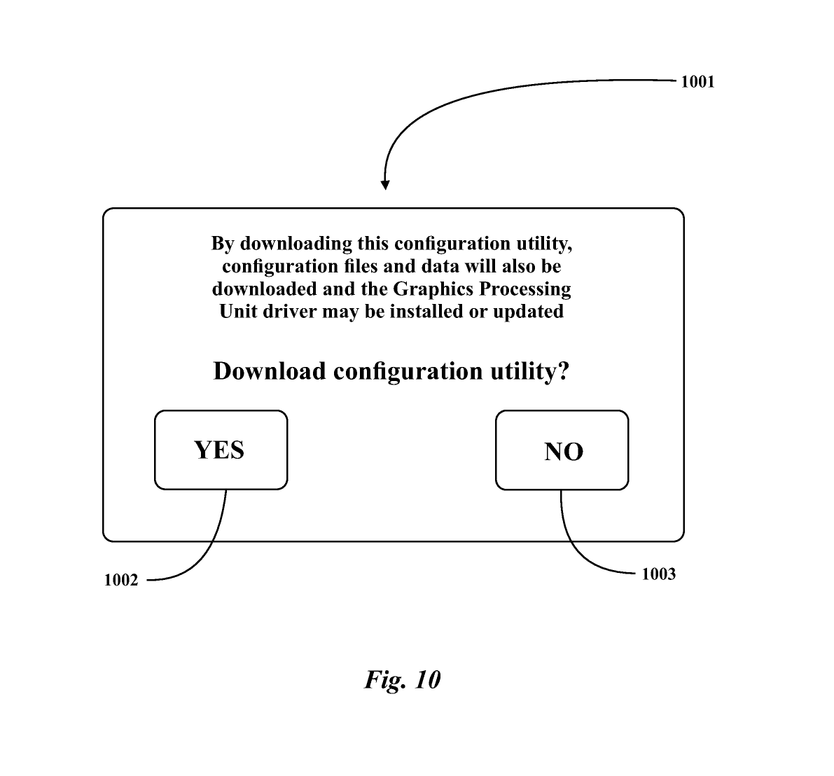

FIG. 10 is an illustration of an exemplary user prompt 1001 enquiring if a user wishes to download a configuration utility and advising that configuration files and data will be downloaded and a GPU driver may be installed or updated. Buttons are provided for the user to respond in the affirmative marked YES 1002 or in the negative marked NO 1003. Should the user select YES 1002 then in accordance with flow chart FIG. 7, step 701, control will pass to step 702 and initiate the entire flow chart sequence. In the event the user selects NO 1003, then, in accordance with flow chart FIG. 7, step 701, control will pass to step 708 to exit the configuration utility.

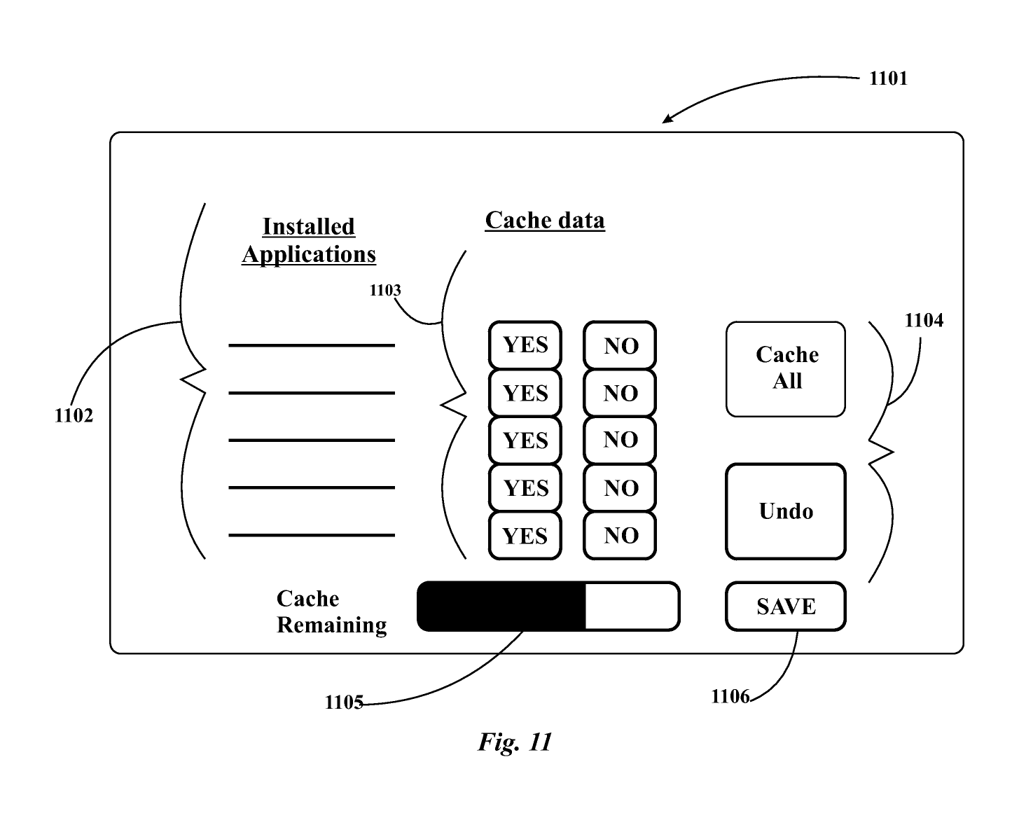

FIG. 11 is an illustration of an exemplary interactive interface with indicia 1101 allowing a user to configure a computer for optimization of applications requiring a graphics card to execute in accordance with flow chart FIG. 4, step 402. The interactive interface 1101 may have a list of installed applications 1102 on a computing appliance that would benefit if configuration files and data were found when the host system scan completed, step 403. Additionally, the interactive interface 1101 might provide options for the user to choose to cache any data found with buttons marked YES and NO 1103. Alternatively the interactive interface 1101 may have an option button to cache all found data indiscriminately marked Cache All 1104 and if selected in error a button might be provided to reverse that selection marked Undo. Once configuration has been finalized the interactive interface 1101 might request the selected options be saved by pressing a button marked SAVE 1106. Some decisions to cache data in accordance with indicium 1103 might be influenced by how much cache space was remaining. To facilitate these decisions the interactive interface 1101 might have a gauge showing the space available in the cache 1105 changeable with each selected or deselected cache operation 1103 or 1104.

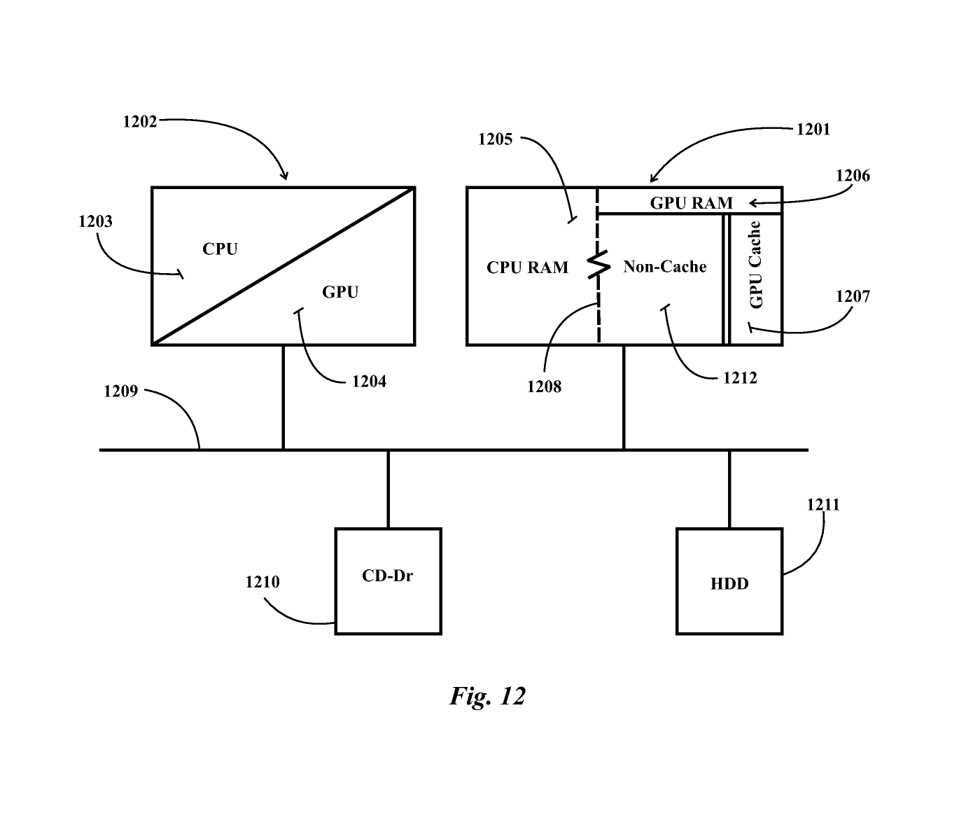

FIG. 12 is a block diagram illustrating elements of general-purpose computer 101, including a CPU 1203 and a GPU 1204 cast on a single die 1202, hard disk drive (HDD) 1211, a CD drive 1210, a RAM memory system 1201 and an interconnecting bus 1209. Bus 1209 is representative of all wires, cables and other hardware and appliances that connect the illustrated elements of the computer system to one another. The RAM memory system 1201 is shared by the CPU 1203 and the GPU 1204 in that there is a variable boundary 1208 separating a CPU RAM 1205 and a GPU RAM 1206. GPU RAM 1206 is illustrated as partitioned into a cache portion 1207 and a non-cache portion 1212, which is accomplished by the driver in various embodiments, directed by the configuration utility for a particular program. In various embodiments of the invention cache 1207 is configured to operate selectively with applications that require a graphics card.

The skilled person will understand that the embodiments described above are exemplary, and not limiting. There are many alterations that may be made, and other embodiments may be created by blending portions of the embodiments described. The invention is limited only by the claims that follow.

1. A method comprising:
searching storage media of a computing appliance for application-specific configuration files by executing a configuration utility from a non-transitory storage medium of the computing appliance;
upon finding an application-specific configuration file, directing a graphics processing unit (GPU) driver to partition a portion of GPU random access memory (RAM) as cache; and
loading data specified in the configuration file to the cache portion partitioned in the GPU RAM.

2. The method of claim 1 further comprising:
determining whether the GPU driver is compatible with the configuration utility; and
if not, downloading and installing a compatible driver.

3. The method of claim 2 further comprising:
enabling a user to determine whether or not to download the compatible driver.

4. The method of claim 1 further comprising:
downloading one or more of the configuration utility, GPU driver, and data from an Internet-connected server.

5. The method of claim 1 further comprising:
executing the configuration utility by executing the GPU driver, the configuration utility being a part of code of the GPU driver.

6. The method of claim 1 further comprising:
determining if there is sufficient GPU RAM available prior to partitioning.

7. The method of claim 6 further comprising:
creating an error log when there is insufficient GPU RAM available.

8. The method of claim 1 further comprising:
after initiating the configuration utility, opening an interactive interface enabling a user to select configuration options.

9. An apparatus comprising:
a computing appliance executing instructions by a processor from a non-transitory storage medium, the instructions causing the processor to perform a process comprising:
searching storage media of the computing appliance for application-specific configuration files by executing a configuration utility from a non-transitory storage medium of the computing appliance;
upon finding an application-specific configuration file, directing a graphics processing unit (GPU) driver to partition a portion of GPU random access memory (RAM) as cache; and
loading data specified in the configuration file to the cache portion partitioned in the GPU RAM.

10. The apparatus of claim 9 further comprising:
causing the processor to determine whether the GPU driver is compatible with the configuration utility; and
if not, downloading and installing a compatible driver.

11. The apparatus of claim 9 further comprising:
enabling a user to determine whether or not to download the compatible driver.

12. The apparatus of claim 9 further comprising:
downloading one or more of the configuration utility, GPU driver, and data from an Internet-connected server.

13. The apparatus of claim 9 further comprising:
executing the configuration utility by executing the GPU driver, the configuration utility being a part of code of the GPU driver.

14. The apparatus of claim 8 further comprising:
determining if there is sufficient GPU RAM available prior to partitioning.

15. The apparatus of claim 14 further comprising:
creating an error log when there is insufficient GPU RAM available.

16. The apparatus of claim 8 further comprising:
after initiating the configuration utility, opening an interactive interface enabling a user to select configuration options.

17. The method of claim 1 wherein the graphics processing unit (GPU) and a central processing unit (CPU) are implemented on a common die, and the processing units share a common random access memory (RAM), a portion of the RAM being dedicated to the GPU, and a portion of the GPU RAM being partitioned as cache.

18. The apparatus of claim 9 wherein the graphics processing unit (GPU) and a central processing unit (CPU) are implemented on a common die, and the processing units share a common random access memory (RAM), a portion of the RAM being dedicated to the GPU, and a portion of the GPU RAM being partitioned as cache.
